(19) United States
(12) Patent Application Publication
(10) Pub. No.: US 2025/0245802 A1
(43) Pub. Date: Jul. 31, 2025

(54) AUTOMATING QUALITY CONTROL FOR 3-DIMENSIONAL ASSETS

(71) Applicant: WALMART APOLLO, LLC, Bentonville, AR (US)

(72) Inventors: Yash Garg, Sunnyvale, CA (US); Himani Saini, Mississauga (CA); Abhimanyu Chadha, San Francisco, CA (US); Oskar Vincent Radermecker, Mountain View, CA (US); Vadivel Palaniappan, Mississauga (CA); Deepa Mohan, Los Altos, CA (US)

(73) Assignee: WALMART APOLLO, LLC, Bentonville, AR (US)

(21) Appl. No.: 19/041,872

(22) Filed: Jan. 30, 2025

Related U.S. Application Data
(60) Provisional application No. 63/627,411, filed on Jan. 31, 2024.

(51) Int. Cl. G06T 7/00; G06T 5/40; G06T 7/11; G06T 7/194; G06T 7/90; G06V 10/54; G06V 10/762

(52) U.S. Cl. CPC G06T 7/0002; G06T 5/40; G06T 7/11; G06T 7/194; G06T 7/90; G06V 10/54; G06V 10/762; G06T 2207/20084; G06T 2207/30168

(57) ABSTRACT

A system including a processor and a non-transitory computer-readable media storing computing instructions that, when executed on the processor, cause the processor to perform certain operations. The operations can include obtaining a rendered image for a 3D-asset generated from a reference image of an object. The operations also can include generating, using a machine learning model, a color score for the rendered image based on a first color histogram for the rendered image and a second color histogram for the reference image. The operations additionally can include generating, using a deep learning model and a slice loss function, a texture score for the rendered image. The acts operations can include determining a quality score for the rendered image based on a predetermined quality threshold and a combination of the color score and the texture score. Other embodiments are described.

### CROSS-REFERENCE TO RELATED APPLICATION

This application claims the benefit of U.S. Provisional Application No. 63/627,411, filed Jan. 31, 2024, which is incorporated herein by reference in its entirety.

### TECHNICAL FIELD

This disclosure relates generally to automating a quality control review for 3-dimensional assets.

### BACKGROUND

Conventionally a 3-dimensional (3D) asset is reviewed for quality standards by using a manual quality control check. The manual quality control check is subject to inconsistency due to subjective bias of each reviewer. For example, a manually reviewed quality control check compares the 3D-asset and a reference image for similarities of color, texture, geometric similarity, and/or another suitable type of manual quality check. Manual quality checks can be time-consuming, inefficient for matters of scale, and expensive.

### BRIEF DESCRIPTION OF THE DRAWINGS

To facilitate further description of the embodiments, the following drawings are provided in which:

FIG. 1 illustrates a front elevational view of a computer system that is suitable for implementing an embodiment of the system disclosed in FIG. 3;

FIG. 2 illustrates a representative block diagram of an example of the elements included in the circuit boards inside a chassis of the computer system of FIG. 1;

FIG. 3 illustrates a block diagram of a system that can be employed for automatically generating a quality score for a 3D-asset (e.g., 3D model);

FIG. 4 illustrates a flow chart for a method describing how an automated quality control (QC) pipeline is initiated to perform an artificial intelligence (AI) quality control check for a generated 3D-asset from a 2D image in a catalog, according to an embodiment;

FIG. 5 illustrates a flow chart for a method of determining a color QC score for the 3D image, according to an embodiment;

FIG. 5A illustrates a flow chart of an activity of generating, using k-means clustering algorithm, multiple color clusters, according to an embodiment;

FIG. 5B illustrates a flow chart of an activity of resolving color mapping between the color clusters, according to an embodiment;

FIG. 5C illustrates a flow chart of an activity of determining, using a scoring algorithm, color scores for the rendered image based on a degree of similarity matching the reference image, according to an embodiment;

FIG. 6 illustrates a flow chart for a method of determining a texture QC score for the rendered image, according to an embodiment;

FIG. 6A illustrates a flow chart of an activity of breaking down each image of the two images into tiles (e.g., small squares) as part of a texture comparison process, according to an embodiment;

FIG. 6B illustrates a flowchart of an activity of generating, using deep learning models, embeddings, according to an embodiment;

FIG. 7 illustrates a flow chart for a method of automatically performing an artificial intelligence assisted quality control review of a 3D-asset, according to another embodiment;

FIG. 8 illustrates a flow chart for a method of automatically generating, using a color quality scoring algorithm in a machine learning model, a color score of the 3D-asset based on a comparison of the reference image of the catalog object, according to another embodiment; and

FIG. 9 illustrates a flow chart for a method of automatically determining, using a texture quality control evaluation algorithm of a machine learning model to generate a texture quality score, according to another embodiment.

### DETAILED DESCRIPTION

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

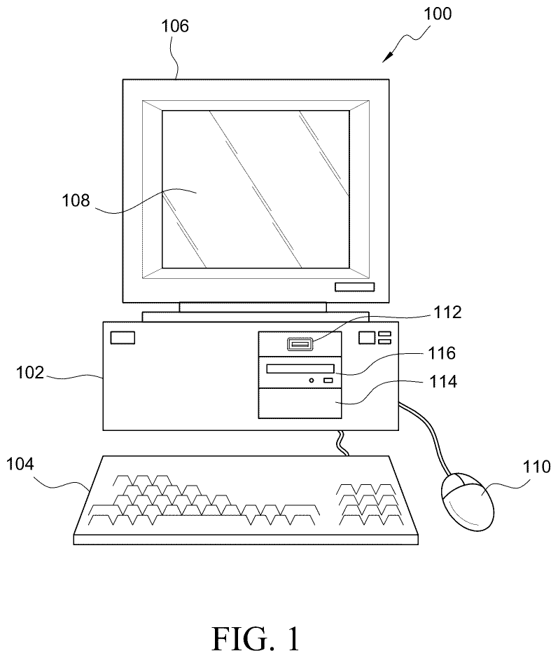

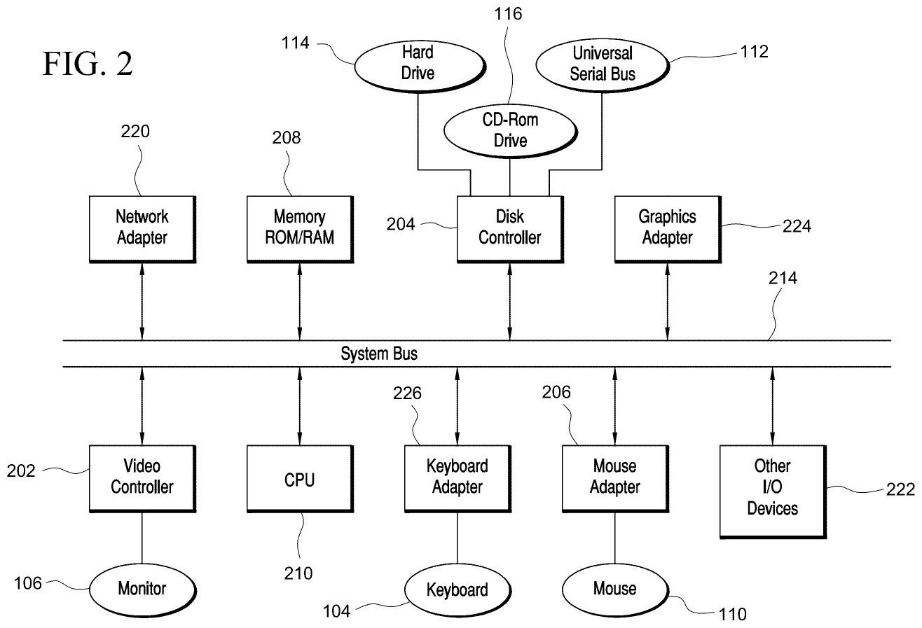

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 100 (and its internal components, or one or more elements of computer system 100) can be suitable for implementing part or all of the techniques described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to memory storage unit 208 that includes both read only memory (ROM) and random access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can include microcode such as a Basic Input-Output System (BIOS). In some examples, the one or more memory storage units of the various embodiments disclosed herein can include memory storage unit 208, a USB-equipped electronic device (e.g., an external memory storage unit (not shown) coupled to universal serial bus (USB) port 112 (FIGS. 1-2)), hard drive 114 (FIGS. 1-2), and/or CD-ROM, DVD, Blu-Ray, or other suitable media, such as media configured to be used in CD-ROM and/or DVD drive 116 (FIGS. 1-2). Non-volatile or non-transitory memory storage unit(s) refer to the portions of the memory storage units(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Exemplary operating systems can include one or more of the following: (i) Microsoft® Windows® operating system (OS) by Microsoft Corp. of Redmond, Washington, United States of America, (ii) Mac® OS X by Apple Inc. of Cupertino, California, United States of America, (iii) UNIX® OS, and (iv) Linux® OS. Further exemplary operating systems can comprise one of the following: (i) the iOS® operating system by Apple Inc. of Cupertino, California, United States of America, (ii) the Blackberry® operating system by Research In Motion (RIM) of Waterloo, Ontario, Canada, (iii) the WebOS operating system by LG Electronics of Seoul, South Korea, (iv) the Android™ operating system developed by Google, of Mountain View, California, United States of America, (v) the Windows Mobile™ operating system by Microsoft Corp. of Redmond, Washington, United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to a keyboard 104 (FIGS. 1-2) and a mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing a monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM and/or DVD drive 116 (FIGS. 1-2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 (FIG. 1) by having wireless communication capabilities integrated into the motherboard chipset (not shown), or implemented via one or more dedicated wireless communication chips (not shown), connected through a PCI (peripheral component interconnector) or a PCI express bus of computer system 100 (FIG. 1) or USB port 112 (FIG. 1). In other embodiments, network adapter 220 can comprise and/or be implemented as a wired network interface controller card (not shown).

Although many other components of computer system 100 (FIG. 1) are not shown, such components and their interconnection are well known to those of ordinary skill in the art. Accordingly, further details concerning the construction and composition of computer system 100 (FIG. 1) and the circuit boards inside chassis 102 (FIG. 1) are not discussed herein.

When computer system 100 in FIG. 1 is running, program instructions stored on a USB drive in USB port 112, on a CD-ROM or DVD in CD-ROM and/or DVD drive 116, on hard drive 114, or in memory storage unit 208 (FIG. 2) are executed by CPU 210 (FIG. 2). A portion of the program instructions, stored on these devices, can be suitable for carrying out all or at least part of the techniques described herein. In various embodiments, computer system 100 can be reprogrammed with one or more modules, system, applications, and/or databases, such as those described herein, to convert a general purpose computer to a special purpose computer. For purposes of illustration, programs and other executable program components are shown herein as discrete systems, although it is understood that such programs and components may reside at various times in different storage components of computer system 100, and can be executed by CPU 210. Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs.

Although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile device, such as a smartphone. In certain additional embodiments, computer system 100 may comprise an embedded system.

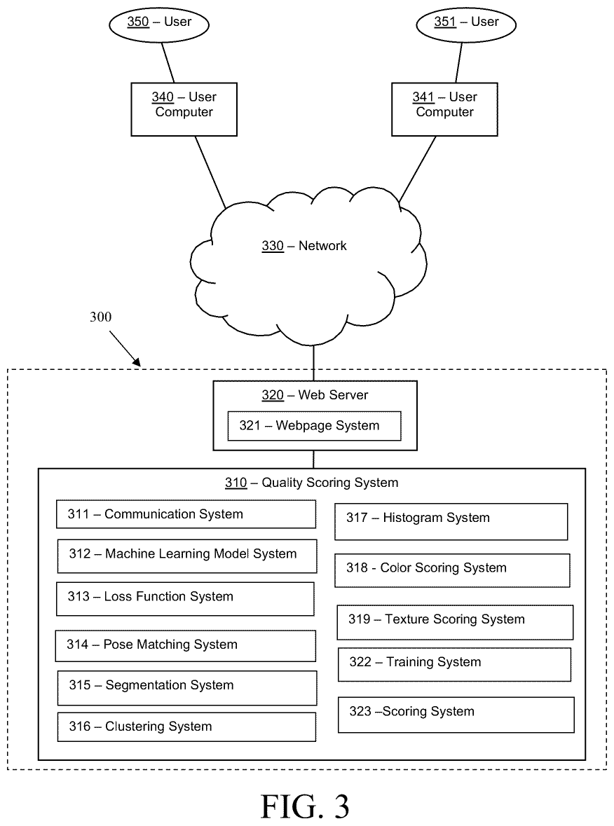

Turning ahead in the drawings, FIG. 3 illustrates a block diagram of a system 300 that can be employed for automatically generating a quality score for a 3D-asset (e.g., 3D model). System 300 is merely exemplary and embodiments of the system are not limited to the embodiments presented herein. The system can be employed in many different embodiments or examples not specifically depicted or described herein. In some embodiments, certain elements, modules, or systems of system 300 can perform various procedures, processes, and/or activities. In other embodiments, the procedures, processes, and/or activities can be performed by other suitable elements, modules, or systems of system 300. System 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

In many embodiments, system 300 can include a quality scoring system 310 and/or a web server 320. Quality scoring system 310 and/or web server 320 can each be a computer system, such as computer system 100 (FIG. 1), as described above, and can each be a single computer, a single server, or a cluster or collection of computers or servers, or a cloud of computers or servers. In another embodiment, a single computer system can host two or more of, or all of, quality scoring system 310 and/or web server 320. Additional details regarding quality scoring system 310 and/or web server 320 are described herein.

In a number of embodiments, each system of quality scoring system 310 and/or web server 320 can be a special-purpose computer programed specifically to perform specific functions not associated with a general-purpose computer, as described in greater detail below.

In some embodiments, web server 320 can be in data communication through a network 330 with one or more user computers, such as user computers 340 and/or 341. Network 330 can be a public network, a private network, or a hybrid network. In some embodiments, user computers 340-341 can be used by users, such as users 350 and 351, which also can be referred to as customers, in which case, user computers 340 and 341 can be referred to as customer computers. In many embodiments, web server 320 can host one or more sites (e.g., websites) that allow users to browse and/or search for items (e.g., products), to add items to an electronic shopping cart, and/or to order (e.g., purchase) items, in addition to other suitable activities.

In some embodiments, an internal network that is not open to the public can be used for communications between quality scoring system 310 and/or web server 320 within system 300. Accordingly, in some embodiments, quality scoring system 310 (and/or the software used by such systems) can refer to a back end of system 300, which can be operated by an operator and/or administrator of system 300, and web server 320 (and/or the software used by such system) can refer to a front end of system 300, and can be accessed and/or used by one or more users, such as users 350-351, using user computers 340-341, respectively. In these or other embodiments, the operator and/or administrator of system 300 can manage system 300, the processor(s) of system 300, and/or the memory storage unit(s) of system 300 using the input device(s) and/or display device(s) of system 300.

In certain embodiments, user computers 340-341 can be desktop computers, laptop computers, a mobile device, and/or other endpoint devices used by one or more users 350 and 351, respectively. A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile device can include a volume and/or weight sufficiently small as to permit the mobile device to be easily conveyable by hand. For examples, in some embodiments, a mobile device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile device can weigh less than or equal to 15.6 Newtons, 17.8 Newtons, 22.3 Newtons, 31.2 Newtons, and/or 44.5 Newtons.

Exemplary mobile devices can include (i) an iPod®, iPhone®, iTouch®, iPad®, MacBook® or similar product by Apple Inc. of Cupertino, California, United States of America, (ii) a Blackberry® or similar product by Research in Motion (RIM) of Waterloo, Ontario, Canada, (iii) a Lumia® or similar product by the Nokia Corporation of Keilaniemi, Espoo, Finland, and/or (iv) a Galaxy™ or similar product by the Samsung Group of Samsung Town, Seoul, South Korea. Further, in the same or different embodiments, a mobile device can include an electronic device configured to implement one or more of (i) the iPhone® operating system by Apple Inc. of Cupertino, California, United States of America, (ii) the Blackberry® operating system by Research In Motion (RIM) of Waterloo, Ontario, Canada, (iii) the Palm® operating system by Palm, Inc. of Sunnyvale, California, United States, (iv) the Android™ operating system developed by the Open Handset Alliance, (v) the Windows Mobile™ operating system by Microsoft Corp. of Redmond, Washington, United States of America, or (vi) the Symbian™ operating system by Nokia Corp. of Keilaniemi, Espoo, Finland.

Further still, the term “wearable user computer device” as used herein can refer to an electronic device with the capability to present audio and/or visual data (e.g., text, images, videos, music, etc.) that is configured to be worn by a user and/or mountable (e.g., fixed) on the user of the wearable user computer device (e.g., sometimes under or over clothing; and/or sometimes integrated with and/or as clothing and/or another accessory, such as, for example, a hat, eyeglasses, a wrist watch, shoes, etc.). In many examples, a wearable user computer device can include a mobile device, and vice versa. However, a wearable user computer device does not necessarily include a mobile device, and vice versa.

In specific examples, a wearable user computer device can include a head mountable wearable user computer device (e.g., one or more head mountable displays, one or more eyeglasses, one or more contact lenses, one or more retinal displays, etc.) or a limb mountable wearable user computer device (e.g., a smart watch). In these examples, a head mountable wearable user computer device can be mountable in close proximity to one or both eyes of a user of the head mountable wearable user computer device and/or vectored in alignment with a field of view of the user.

In more specific examples, a head mountable wearable user computer device can include (i) Google Glass™ product or a similar product by Google Inc. of Menlo Park, California, United States of America; (ii) the Eye Tap™ product, the Laser Eye Tap™ product, or a similar product by ePI Lab of Toronto, Ontario, Canada, and/or (iii) the Raptyr™ product, the STAR 1200™ product, the Vuzix Smart Glasses M100™ product, or a similar product by Vuzix Corporation of Rochester, New York, United States of America. In other specific examples, a head mountable wearable user computer device can include the Virtual Retinal Display™ product, or similar product by the University of Washington of Seattle, Washington, United States of America. Meanwhile, in further specific examples, a limb mountable wearable user computer device can include the iWatch™ product, or similar product by Apple Inc. of Cupertino, California, United States of America, the Galaxy Gear or similar product of Samsung Group of Samsung Town, Seoul, South Korea, the Moto 360 product or similar product of Motorola of Schaumburg, Illinois, United States of America, and/or the Zip™ product, One™ product, Flex™ product, Charge™ product, Surge™ product, or similar product by Fitbit Inc. of San Francisco, California, United States of America.

In several embodiments, system 300 can include one or more input devices (e.g., one or more keyboards, one or more keypads, one or more pointing devices such as a computer mouse or computer mice, one or more touchscreen displays, a microphone, etc.), and/or can each include one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to system 300 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processor(s) and/or the memory storage unit(s). In some embodiments, the KVM switch also can be part of system 300. In a similar manner, the processors and/or the non-transitory computer-readable media can be local and/or remote to each other.

Meanwhile, in many embodiments, system 300 also can be configured to communicate with and/or include one or more databases. The one or more databases can include a 3D-asset database that contains validated (e.g., quality check review) 3D-assets for use in a virtual environment, such as AR scene, VTO environment, and another suitable digital space, and product database that contains information about products, items, or SKUs (stock keeping units), for example, among other data as described herein, such as described herein in further detail. The one or more databases can be stored on one or more memory storage units (e.g., non-transitory computer readable media), which can be similar or identical to the one or more memory storage units (e.g., non-transitory computer readable media) described above with respect to computer system 100 (FIG. 1). Also, in some embodiments, for any particular database of the one or more databases, that particular database can be stored on a single memory storage unit or the contents of that particular database can be spread across multiple ones of the memory storage units storing the one or more databases, depending on the size of the particular database and/or the storage capacity of the memory storage units.

The one or more databases can each include a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, communication between system 300, network 330, and/or the one or more databases can be implemented using any suitable manner of wired and/or wireless communication. Accordingly, system 300 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can include Bluetooth, Zigbee, Wireless Universal Serial Bus (USB), Z-Wave, etc.; exemplary LAN and/or WAN protocol(s) can include Institute of Electrical and Electronic Engineers (IEEE) 802.3 (also known as Ethernet), IEEE 802.11 (also known as WiFi), etc.; and exemplary wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, exemplary communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can include wireless communication hardware including, for example, one or more radio transceivers, one or more infrared transceivers, etc. Additional exemplary communication hardware can include one or more networking components (e.g., modulator-demodulator components, gateway components, etc.).

In many embodiments, quality scoring system 310 can include a communication system 311, a machine learning model system 312, a loss function system 313, a pose matching system 314, a segmentation system 315, a clustering system 316, a histogram system 317, a color scoring system 318, a texture scoring system 319, a training system 322, and/or a scoring system 323. In many embodiments, the systems of quality scoring system 310 can be modules of computing instructions (e.g., software modules) stored at non-transitory computer readable media that operate on one or more processors. In other embodiments, the systems of quality scoring system 310 can be implemented in hardware. Quality scoring system 310 can be a computer system, such as computer system 100 (FIG. 1), as described above, and can be a single computer, a single server, or a cluster or collection of computers or servers, or a cloud of computers or servers. In another embodiment, a single computer system can host quality scoring system 310. Additional details regarding quality scoring system 310 and the components thereof are described herein.

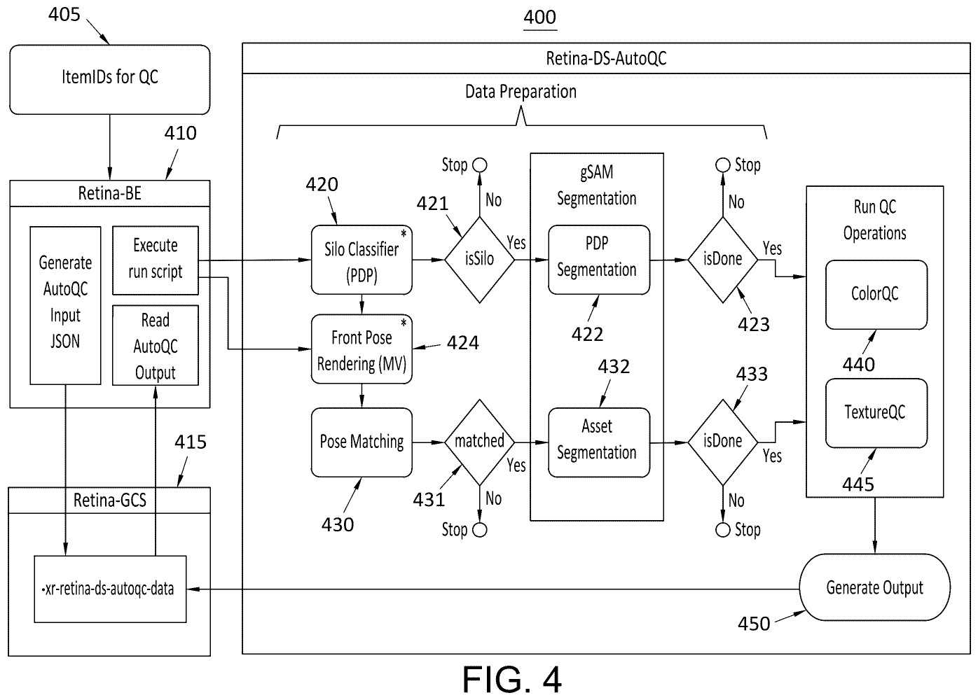

Turning ahead in the drawings, FIG. 4 illustrates a flow chart for a method 400 describing how an automated quality control (QC) pipeline is initiated to perform an artificial intelligence (AI) quality control check for a generated 3D-asset from a 2D image in a catalog, according to an embodiment. In various embodiments, the automated QC pipeline can measure multiple aspects of quality control corresponding to a quality threshold measure of a rendered image (e.g., 3D-asset) compared to a reference image. In some embodiments, the aspects of quality control measured by the automated QC pipeline can include one or more of: missing parts in the rendered image, adding parts in the rendered image that are not in the object, mismatched geometry between the rendered image and the reference image, variation in color, variations in texture, variations in photometric lighting, variations in image background in the 2D image, and/or another suitable quality aspect measure.

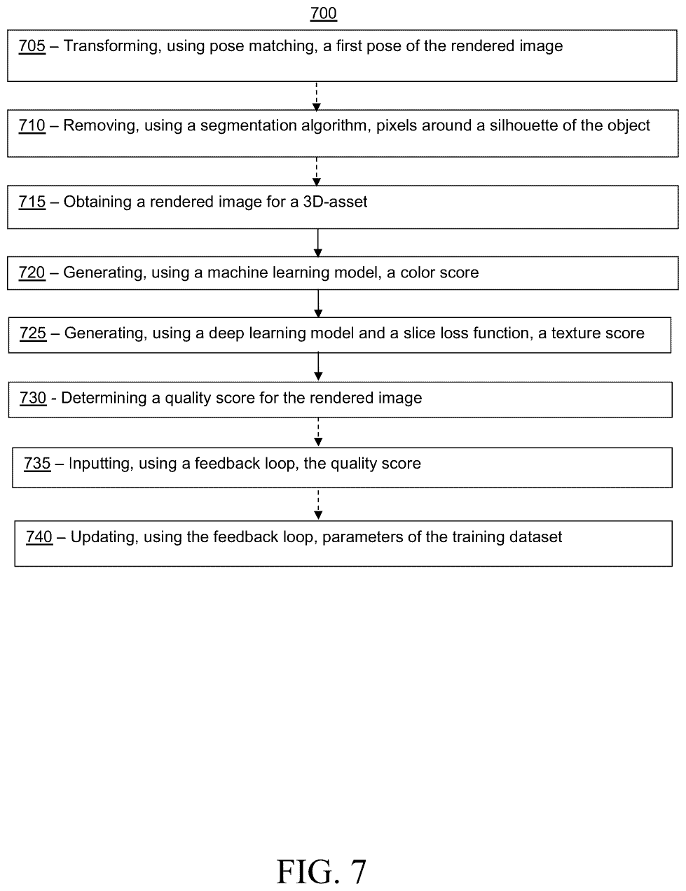

Method 400 additionally can illustrate generating a combined quality score for the 3D-asset, such that when a quality score for the 3D-asset meets or exceeds a quality threshold, the 3D-asset can be used in multiple digital environments and pushed into a production environment. Method 400 also can illustrate another process outside of the automated quality control pipeline when the 3D-asset falls below the quality threshold by regenerating the 3D-asset using a feedback loop. Method 400 can be similar to the activities performed in connection with method 700 (FIG. 7, described below). Method 400 can be employed in many different embodiments and/or examples not specifically depicted or described herein. In some embodiments, the procedures, the processes, and/or the activities of method 400 can be performed in the order presented or in parallel. In other embodiments, the procedures, the processes, and/or the activities of method 400 can be performed in any suitable order. In still other embodiments, one or more of the procedures, the processes, and/or the activities of method 400 can be combined or skipped. In several embodiments, system 300 (FIG. 3) can be suitable to perform method 400 and/or one or more of the activities of method 400.

In these or other embodiments, one or more of the activities of method 400 can be implemented as one or more computing instructions configured to run at one or more processors and configured to be stored at one or more non-transitory computer-readable media. Such non-transitory computer-readable media can be part of a computer system such as quality scoring system 310 and/or web server 320. The processor(s) can be similar or identical to the processor(s) described above with respect to computer system 100 (FIG. 1).

In several embodiments, method 400 can include obtaining 3D images 405 of artist generated 3D images of corresponding 2D images from a catalog, where tine 3D images are identified by a product itemID. In some embodiments, the 3D images can be identified by digital itemIDs (e.g., digital identification values or machine-readable identification values) of objects and/or items.

In various embodiments, method 400 can include an activity 410 of selecting the 3D images 405 for use in the AI quality control pipeline (e.g., architecture). In several embodiments, activity 410 can include executing a command to run a script and/or computing instructions to generate a digital reference image and a digital rendered image of the object (e.g., item). In many embodiments, activity 410 also can transmit the reference image as an input to an activity 420 and the rendered image as an input to an activity 430 as part of data preparation for activity 440 and activity 445 (described below). In various embodiments, activity 410 (e.g., Retina-BE), also can generate automated quality control input using 3D images 405 (e.g., JSON data images). In some embodiments, 3D images 405 can be transmitted to a database 415 (e.g., Retina-GCS). In several embodiments, database 415 also can be used to retrieve 3D images for activity 410 to be read as Automated QC output images.

In a number of embodiments, method 400 can include activity 420 of classifying, using a silo image classifier, the 3D image into either a silo image or a non-silo image. In several embodiments, activity 420 also can include rendering, using a deep learning model of a machine learning framework, the reference image into a frontal pose in preparation for input as the reference image used in activity 421 and activity 430 (described below). In various embodiments, the silo image classifier can be trained on historical images of objects including silo images over a period of time. For example, the historical images can include images and/or digital images from an online catalog and/or images uploaded by a vendor or third-party. In some embodiments, the historical images are updated periodically so that the artificial intelligence in the silo image classifier continues to learn to identify silo images, such as, when the images are in a machine-readable format which cannot be identified by a mental process by a human. In many embodiments, activity 420 can select an optimal silo image from among multiple silo images classified by activity 420 for use as the reference image as processed down along the Automated QC pipeline.

In some embodiments, activity 420 can transmit the reference image to an activity 421 of determining whether or not to approve the reference image as an optimal reference image for input into activity 422. In several embodiment, activity 421 can include determining whether or not the reference image meets or exceeds a predetermined quality threshold. If the output of activity 421 is yes, method 400 can proceed to an activity 422. If the output of activity 421 is no, method 400 can reject and/or discard that reference image from the automated QC pipeline as falling below the predetermined quality threshold.

In several embodiments, method 400 can include an activity 424 of rendering, using a deep learning model of a machine learning framework, the reference image into a frontal pose in preparation for input as the reference image used in activity 424 and activity 440 (described below). In some embodiments, the deep learning model can include a neural network to generate pose estimations corresponding to a frontal pose of the reference image where the object of the reference image is viewed in a non-frontal pose. In various embodiments, the deep learning model can include pose matching to generate pose estimations executed by using computer vision approaches to detect a position and orientation of the object and/or a person in the image by predicting locations of particular key points in the image, such as hands, head, elbows, frontal views of an object, side views of the object, and/or other suitable key points in the image. In several embodiments, transforming an image using camera parameter optimization techniques, such as PyTorch, used differential silhouettes rendering camera parameters with different views of the silhouettes of a reference image.

In many embodiments, transforming the image using pose matching also can include techniques using grey scale or RGB imaging that can be an alternative to using silhouette rendering. In several embodiments, advantages of implementing pose matching using grey scale or RGB imaging can include optimizing light location along with camera parameters, using alternative loss functions, and also improving renders by obtaining camera parameters used in a blender technique for the rendering of the image.

Method 400 also can include activity 430. Similar to executing the deep learning model activities in 424, in a number of embodiments, activity 430 also can include executing, using the deep learning model, pose matching on the rendered image to transform the rendered image into a matching equivalent of the frontal pose of the reference image (activity 420).

In several embodiments, activity 430 also can transmit the rendered image in the frontal pose matching the reference image, to an activity 431 of determining whether or not to approve the rendered image as an optimal rendered image for use by an activity 432. In some embodiments, activity 431 can include determining whether or not the rendered image meets or exceeds a predetermined quality threshold. If the output of activity 431 is yes, method 400 can proceed to activity 432. If the output of activity 431 is no, method 400 can reject and/or discard that reference image, post segmentation, from the automated QC pipeline as falling below the predetermined quality threshold.

In various embodiments, after the rendered image and the reference image are matched with frontal poses, the images can next be segmented using activity 422 and activity 432. In many embodiments, activity 422 can include segmenting the reference image by removing pixels surrounding the object of the reference image and removing pixels in the background of the reference image so the object of the image is segmented to be viewed as a silo image.

In several embodiments, activity 422 can include transmitting the reference image, as segmented, to an activity 423 of determining whether or not to approve the reference image, as segmented, as an optimal reference image for use by activity 440, activity 445, and activity 450. In some embodiments, activity 423 can include determining whether or not the reference image, as segmented, meets or exceeds a predetermined quality threshold, post segmentation. If activity 423 is yes, method 400 can proceed to activity 424, activity 440, or activity 445. If activity 423 is no, method 400 can reject and/or discard that reference image, post segmentation, from the automated QC pipeline as falling below the predetermined quality threshold, post segmentation.

In some embodiments, activity 432 also can include segmenting the rendered image in a frontal pose by removing pixels surrounding the object of the image and removing pixels in the background of the rendered image so the object of the rendered image is segmented to be viewed as a silo image.

In various embodiments, activity 432 can transmit the rendered image to an activity 433 of determining whether or not to approve the rendered image, as segmented, as an optimal rendered image for use by activity 440, activity 445, and activity 450. In some embodiments, activity 433 can include determining whether or not the rendered image, as segmented, meets or exceeds a predetermined quality threshold, post segmentation. If the output of activity 433 is yes, method 400 can proceed to activity 440 and activity 445. If the output of activity 433 is no, method 400 can rejection and/or discard that reference image, post segmentation, from the automated QC pipeline as falling below the predetermined quality threshold, pose segmentation.

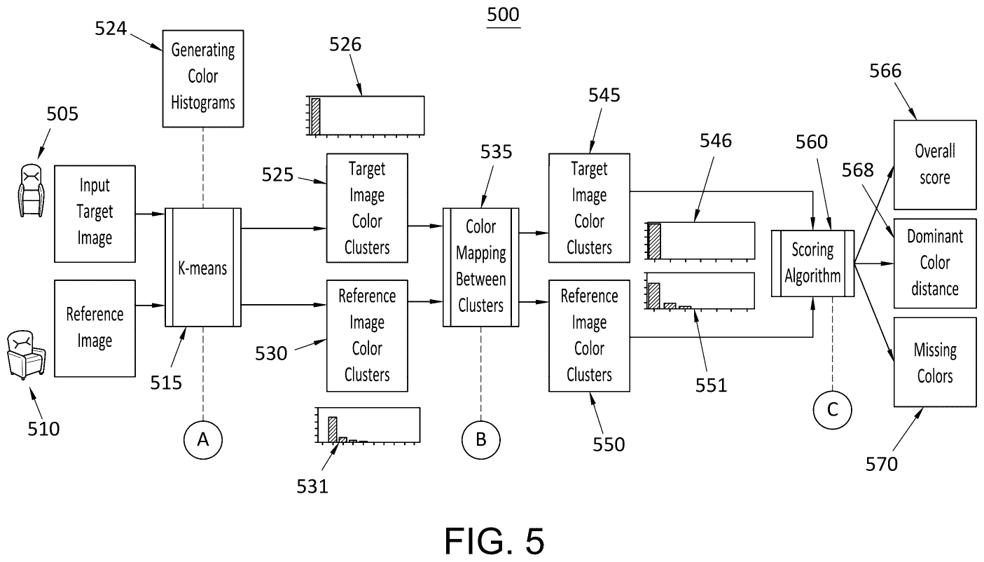

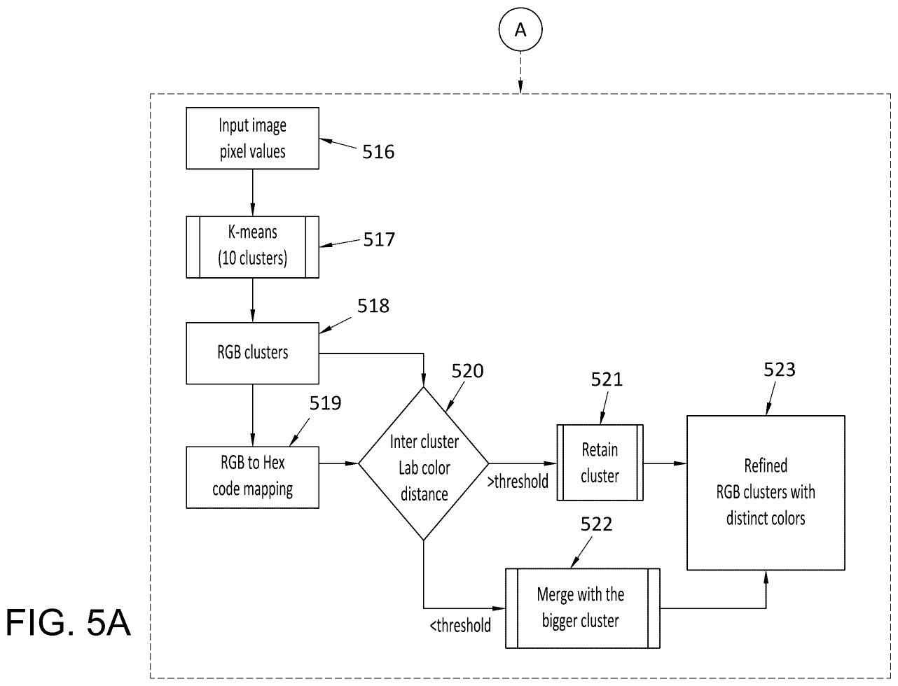

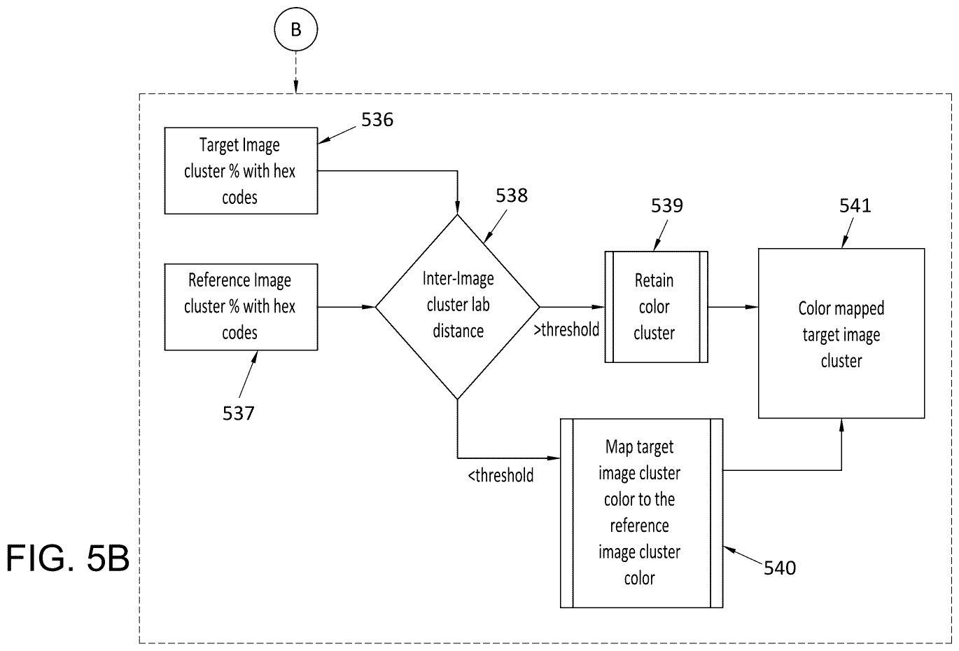

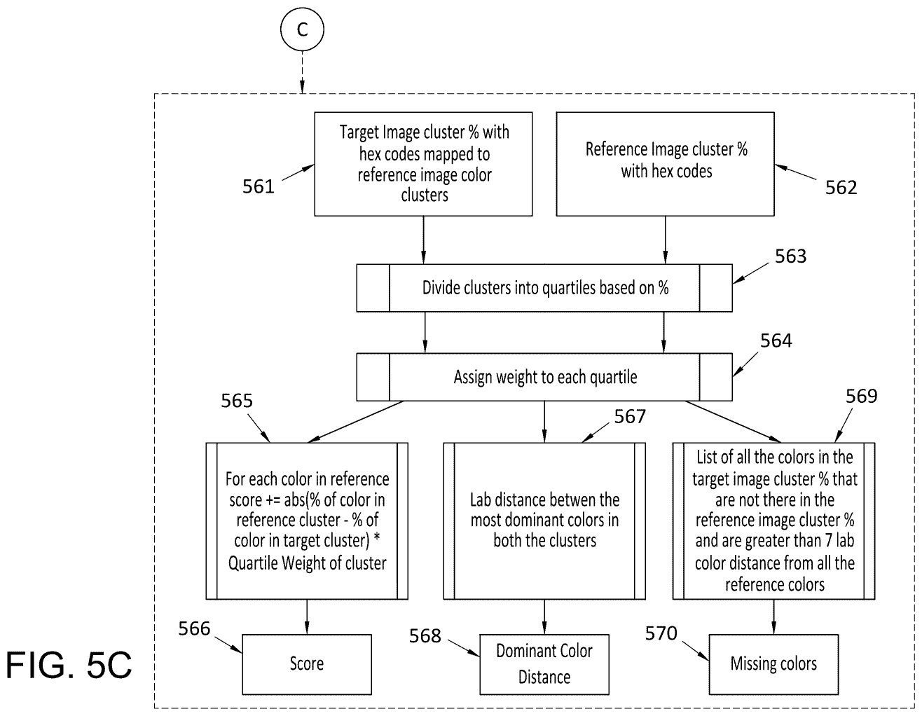

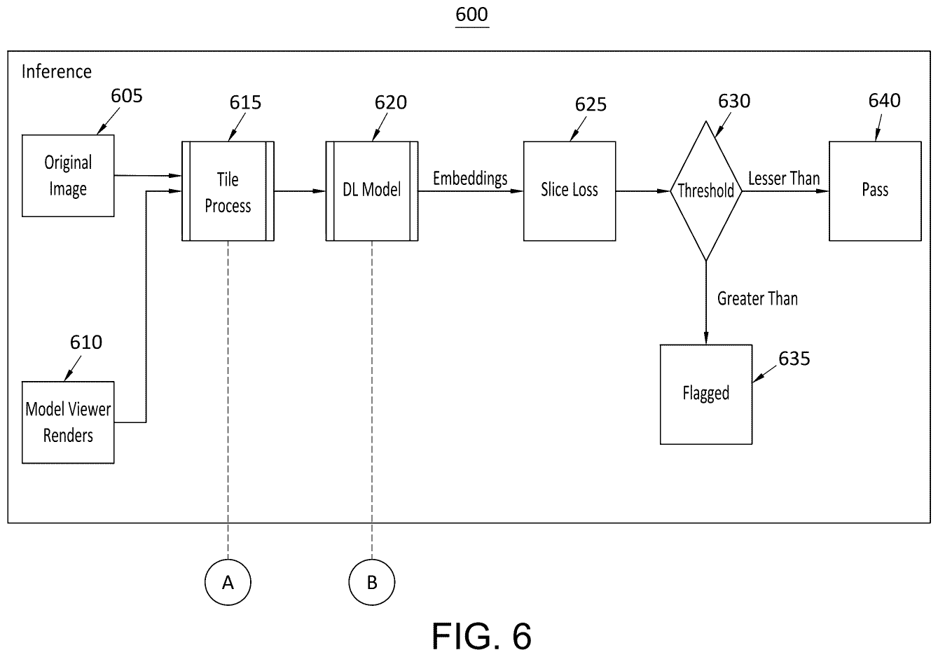

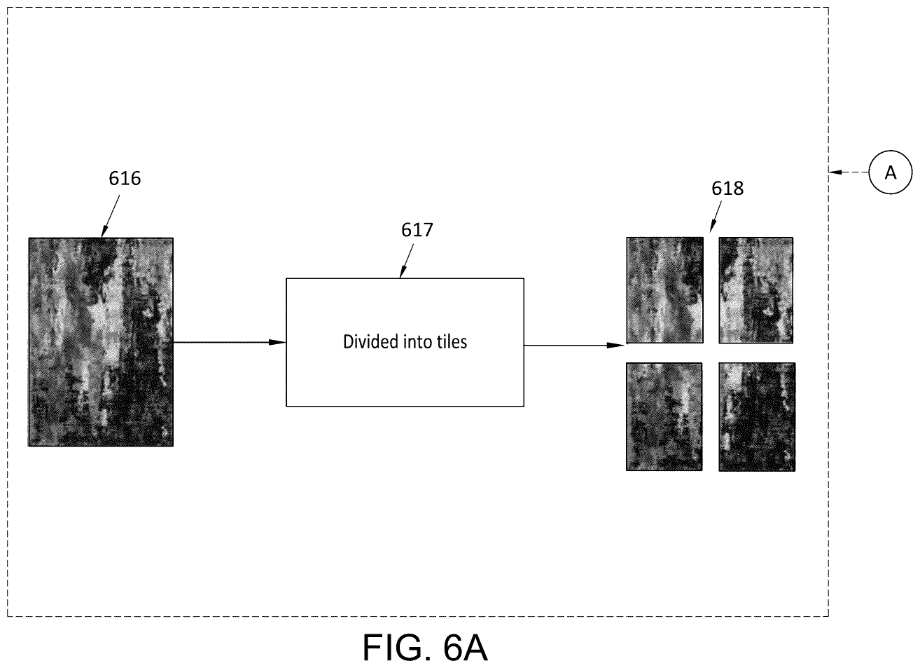

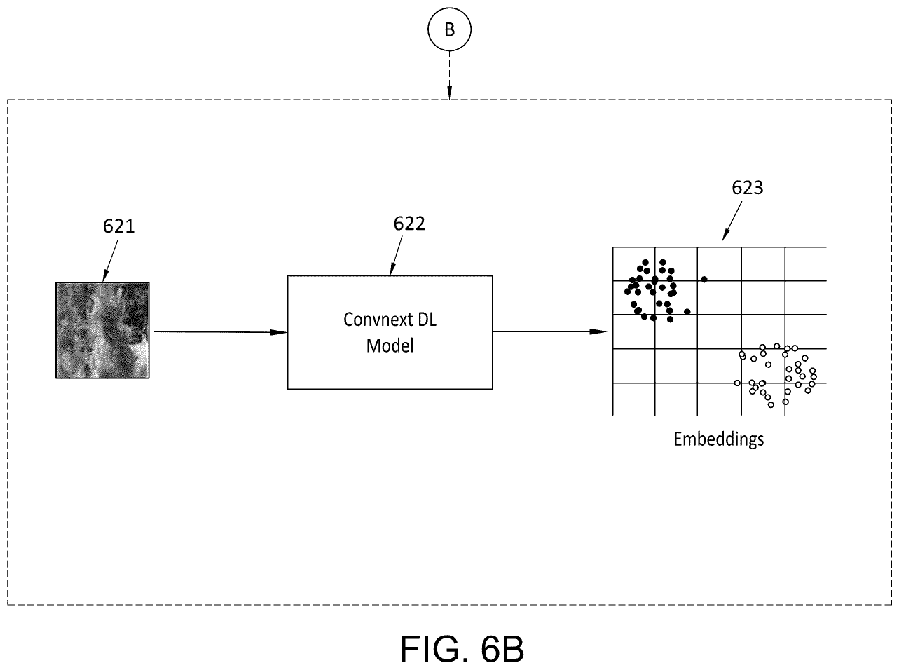

In several embodiments, method 400 can include running the quality control operations by inputting the rendered image and the reference image into activity 440 of passing both of the images into an AI assisted color quality control review and into activity 445 of comparing, using deep learning and a slice loss function, convolutional neural network (e.g., convnext) embeddings both of the images based on similar degrees of texture between the rendered image and the reference image. In various embodiments, activity 440 can output scores to measure similarity levels corresponding to color qualities of the rendered image compared to the reference image. Similarly, in many embodiments, activity 445 can output scores to measure similarity levels corresponding to texture qualities of the rendered image compared to the reference image. In some embodiments, activities 440 and 445 can be implemented as described in greater detail below in connection with FIGS. 5 and 6. In some embodiments, method 400 can proceed after activity 440 and activity 445 to an activity 450.

In various embodiments, activity 450 of validating the rendered image (3D image) can be based on combining a color score and a texture score tied together to provide a pass or fail result based on the scores. In some embodiments, the 3D images when validated can provide a practical application as the 3D images are pushed into production as available 3D images configured to be viewed in an online catalog. In many embodiments, the 3D images when validated also can provide a practical application as the 3D images are configured to be viewed, digitally manipulated and/or rotated 360 degrees in any suitable AI environment.

In some embodiments, rendered images that are unvalidated in the automated QC pipeline, activity 450 also can include transmitting the rendered images unvalidated to a manual quality review. If the rendered images pass a manual quality review, the rendered images are validated and pushed through to production. If the rendered images do not pass the manual quality review, the rendered images are transmitted to an asset review. In various embodiments, activity 450 also include transmitting the rendered images to a feedback loop and/or returning the rendered image to be regenerated by an artist into another 3D image. In some embodiments, activity 450 further can include updating training datasets periodically for use by AI assisted machine learning models as used throughout the automated QC pipeline discussed in FIG. 4. Method 400 further can illustrate how artificial intelligence assisted machine learning models can learn via data from the feedback loop by tracking metrics during and after execution of the automated quality control pipeline.

Turning ahead in the drawings, FIG. 5 illustrates a flow chart for a method 500 of determining a color QC score for the 3D image, according to an embodiment. Method 500 can include using machine learning assisted color histograms to capture proportions of colors in the reference image and the rendered image. Method 500 can be employed in many different embodiments and/or examples not specifically depicted or described herein. In some embodiments, the procedures, the processes, and/or the activities of method 500 can be performed in the order presented or in parallel. In other embodiments, the procedures, the processes, and/or the activities of method 500 can be performed in any suitable order. In still other embodiments, one or more of the procedures, the processes, and/or the activities of method 500 can be combined or skipped. In several embodiments, system 300 (FIG. 3) can be suitable to perform method 500 and/or one or more of the activities of method 500.

In these or other embodiments, one or more of the activities of method 500 can be implemented as one or more computing instructions configured to run at one or more processors and configured to be stored at one or more non-transitory computer-readable media. Such non-transitory computer-readable media can be part of a computer system such as quality scoring system 310 and/or web server 320. The processor(s) can be similar or identical to the processor(s) described above with respect to computer system 100 (FIG. 1).

In several embodiments, method 500 can include an activity 515 of generating, using k-means clustering algorithm, multiple color clusters of colors corresponding to the rendering image and/or the reference image. In several embodiments, generating the color clusters also can be performed by using another suitable pixel-based clustering algorithm. In some embodiments, activity 515 can generate color clusters for image 505 of a rendered image (e.g., a target 3D image) and an image 510 of a reference image.

In some embodiments, prior to obtaining the color histograms of the rendered image and the reference image, method 500 further include extracting, using a segmentation algorithm, the pixels surrounding the object of the rendered image and/or the reference image to optimize histogram color scores.

In several embodiments, method 500 also can include an activity (not shown in FIG. 5) of generating color histograms based on the color clusters generated by the k-means clustering algorithm in activity 515. In some embodiments, generating the color histograms also can include capturing different proportions of the color clusters in the rendered image and the reference image the color histograms. In various embodiments, method 500 additionally can include an activity of determining a color score based on how the proportions of the colors in the rendered image and the reference image are matched in the images as the color histogram includes the color information of the object in the images.

Turning ahead in the drawings, FIG. 5A illustrates a flow chart of activity 515 of generating, using k-means clustering algorithm, multiple color clusters, according to an embodiment. Activity 515 can be employed in many different embodiments and/or examples not specifically depicted or described herein. In some embodiments, the procedures, the processes, and/or the activities of activity 515 can be performed in the order presented or in parallel. In other embodiments, the procedures, the processes, and/or the activities of activity 515 can be performed in any suitable order. In still other embodiments, one or more of the procedures, the processes, and/or the activities of activity 515 can be combined or skipped.

In many embodiments, activity 515 can include an activity 516 of obtaining input image pixel values of an image. In many embodiments, activity 515 also can include activity 517 of using k-means clustering algorithm to obtain clusters of distinct colors for use in machine learning assisted color histograms for an image, such as the rendered image and/or the reference image. In some embodiments, activity 517 can use the image associated with the image pixel values extracted from the rendered image and/or the reference image.

In several embodiments, activity 515 can include activity 518 of creating RGB (Red, Green, Blue color values) clusters from the pixel values extracted from the image. For example, k-means clustering can generate approximately 10 RGB color clusters for a single image. In some embodiments, activity 515 can include mapping the RGB clusters to Hex codes.

In various embodiments, activity 515 can include an activity 520 of determining whether or not the color clusters between two images are similar enough to one another by exceeding a predetermined color distance threshold. If the output of activity 520 is yes, activity 515 can proceed to activity 521 then activity 523. If the output of activity 520 is no, activity 515 can proceed to activity 522 then activity 523.

In some embodiments, activity 520 can include utilizing, using inter cluster lab color distances (lab color distances), to determine a plotted color distance (e.g., color differences) or a separation distance between two colors. In various embodiments, activity 521 can include sorting the colors clusters by retaining the color activity and activity 522 can include merging the two colors with an aggregated (e.g., bigger) color. For example, if the color distance between colors are greater than a predetermined color threshold, the colors are resolved together as one color due the similarity of the colors, the cluster is retained. Such an exemplary predetermining color threshold can be a plotted distance of 6. Further into the example, if clusters with colors with lab color distances less than a predetermined color between two colors can indicate that there are subtle enough color differences between the two colors, the colors are merged with a larger cluster of colors.

In various embodiments, activity 515 can include activity 523 of refining RGB clusters with distinct colors based on the clusters retained in activity 521 or the clusters merged in activity 522.

Returning to FIG. 5, in various embodiments, method 500 also can include an activity 525 of obtaining target image rendered color clusters corresponding to a histogram 526 of the rendered image. As an example, histogram 526 displays one color bar representing the frequency distribution of the color red in the rendered image which in this histogram is approximately 100% of the pixels are mapped to the color red.

In several embodiments, method 500 further can include an activity 530 of obtaining reference image color clusters corresponding to a histogram 531 of the reference image. As an example, histogram 531 displays multiple color bars also representing the frequency distribution of each color in the reference image which in this histogram is approximately 70% of the pixels are mapped to the color red and the remaining 30% of the pixels are mapped to approximately 4 other colors.

In some embodiments, method 500 further can include an activity 535 of resolving color mapping between the color clusters of two images based on pixel distributions of histogram 526 and pixel distributions of histogram 531. In several embodiments, method 500 can proceed after activity 535 to an activity of generating color histograms based on image clusters 545 and image clusters 550. In some embodiments, building color histograms for histogram 546 can be based on using the pixel distributions in image clusters 545. Similarly, building color histograms for histogram 551 can be based on using the pixel distributions in image clusters 550.

Turning forward to the drawings, FIG. 5B illustrates a flow chart of activity 535 of resolving color mapping between the color clusters, according to an embodiment. Activity 535 can be employed in many different embodiments and/or examples not specifically depicted or described herein. In some embodiments, the procedures, the processes, and/or the activities of activity 535 can be performed in the order presented or in parallel. In other embodiments, the procedures, the processes, and/or the activities of activity 535 can be performed in any suitable order. In still other embodiments, one or more of the procedures, the processes, and/or the activities of activity 535 can be combined or skipped.

In some embodiments, activity 535 can include an activity 536 of obtaining a percentage of color clusters with hex codes from a set of color clusters corresponding to the rendered image. In various embodiments, activity 535 also can include an activity 537 of obtaining a percentage of color clusters with hex codes corresponding to the reference image.

In several embodiments, activity 535 can include an activity 538 of determining whether or not to retain a color cluster of an image based on a score exceeding a predetermined threshold. If the output of activity 538 is yes, activity 535 can proceed to activity 539 of retaining the color cluster for input into activity 541. If the output of activity 538 is no, activity 535 can proceed to activity 540 of mapping the color cluster of the rendered image to the color cluster of the reference image.

In several embodiments, method 500 can include activity 541 of color mapping the rendered image based on the color clusters output by activity 539 and activity 540.

Returning to FIG. 5, in various embodiments, method 500 further can include activity 560 of determining, using a scoring algorithm, color scores for the rendered image. In some embodiments, the colors scores can include an overall score 566, a dominant color distance 568, and/or a list of missing colors 570.

Turning ahead in the drawings, FIG. 5C illustrates a flow chart of activity 560 of determining, using a scoring algorithm, color scores for the rendered image based on a degree of similarity matching the reference image, according to an embodiment. Activity 560 can be employed in many different embodiments and/or examples not specifically depicted or described herein. In some embodiments, the procedures, the processes, and/or the activities of activity 560 can be performed in the order presented or in parallel. In other embodiments, the procedures, the processes, and/or the activities of activity 560 can be performed in any suitable order. In still other embodiments, one or more of the procedures, the processes, and/or the activities of activity 560 can be combined or skipped.

In some embodiments, activity 560 can include an activity 561 of the obtaining a percentage of color clusters with hex codes from a set of color clusters of the rendered image mapped to the color clusters of the reference image. In several embodiments, activity 560 can include an activity 562 of obtaining a percentage of color clusters with hex codes from a set of color clusters corresponding to the reference image. In various activities, activity 560 can include an activity 563 of dividing the color clusters into quartiles based on a percentage of color clusters with hex codes. In many embodiments, activity 560 further can include an activity 564 of assigning a weight to each quartile.

In several embodiments, activity 560 can output overall score 566 for the rendered image of based on activity 565. In some embodiments, activity 565 can include determining a total score of the rendered image based on the following formula: for each color in reference score+=abs (a percentage of color in reference image cluster−a percentage of color in the rendered image cluster (e.g., target cluster)*a quartile weigh of a cluster.

In various embodiments, activity 560 can output dominant color distance 568 of the colors for the rendered image based on an activity 567. In several embodiments, a color distance (e.g., lab color distance) can be determined between the most dominant colors in both the color clusters of the rendered image and the reference image.

In some embodiments, activity 560 can output list of missing colors 570 between the rendered image and the reference image based on activity 569. In various embodiments, activity 560 can include activity 569 of determining a list of missing colors between the rendered image and the reference image. In several embodiments, activity 569 can determine the list of missing colors by (i) obtaining a list of all the color in the rendered image based on a cluster percentage with hex codes that are missing from the reference image based on a cluster percentage with hex codes and (ii) listing all of the missing colors of the rendered image that exceed a predetermined threshold color distance from the colors in the reference image. For example, the list can include all of the colors missing from the rendered image with a distance greater than a 7 lab color distance of the reference image colors.

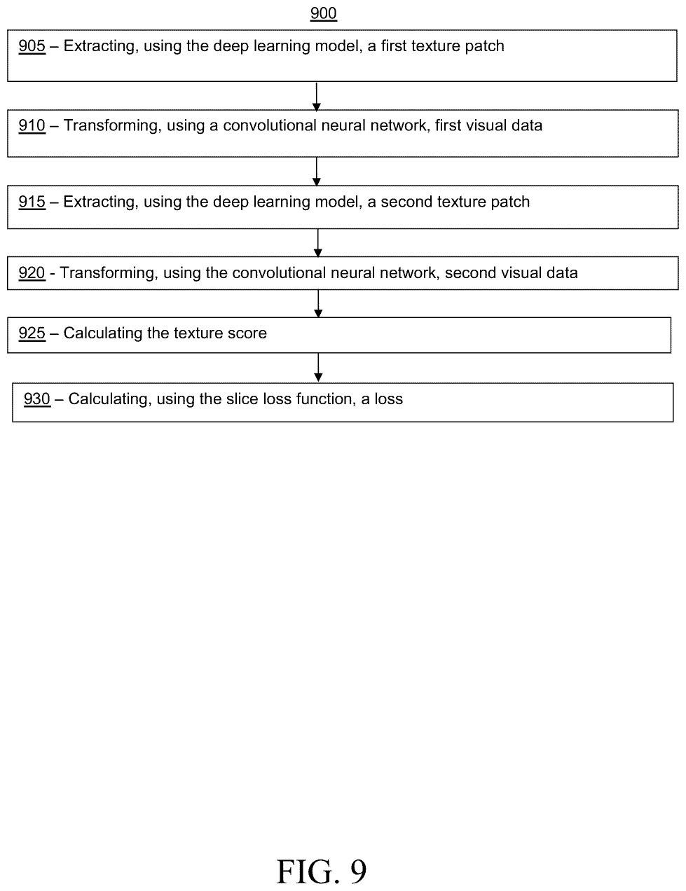

Turning ahead in the drawings, FIG. 6 illustrates a flow chart for a method 600 of determining a texture QC score for the rendered image, according to an embodiment. Method 600 can be similar to the activities performed in connection with method 900 (FIG. 9, described below). Method 600 can be employed in many different embodiments and/or examples not specifically depicted or described herein. In some embodiments, the procedures, the processes, and/or the activities of method 600 can be performed in the order presented or in parallel. In other embodiments, the procedures, the processes, and/or the activities of method 600 can be performed in any suitable order. In still other embodiments, one or more of the procedures, the processes, and/or the activities of method 600 can be combined or skipped. In several embodiments, system 300 (FIG. 3) can be suitable to perform method 600 and/or one or more of the activities of method 600.

In these or other embodiments, one or more of the activities of method 600 can be implemented as one or more computing instructions configured to run at one or more processors and configured to be stored at one or more non-transitory computer-readable media. Such non-transitory computer-readable media can be part of a computer system such as quality scoring system 310 and/or web server 320. The processor(s) can be similar or identical to the processor(s) described above with respect to computer system 100 (FIG. 1).

In several embodiments, method 600 can begin with obtaining an image 605 of a reference image (e.g., original image) and an image 610 of a rendered image (e.g., model viewer renders). In some embodiments, method 600 can include an activity 615 of breaking each image into tiles (e.g., small squares) as part of a texture comparison process. In various embodiments, method 600 can proceed after activity 615 to activity 620.

Turning ahead in the drawings, FIG. 6A illustrates a flow chart of activity 615 of breaking down each image of the two images into tiles (e.g., small squares) as part of a texture comparison process, according to an embodiment. Activity 615 can be employed in many different embodiments and/or examples not specifically depicted or described herein. In some embodiments, the procedures, the processes, and/or the activities of activity 615 can be performed in the order presented or in parallel. In other embodiments, the procedures, the processes, and/or the activities of activity 615 can be performed in any suitable order. In still other embodiments, one or more of the procedures, the processes, and/or the activities of activity 615 can be combined or skipped.

In many embodiments, activity 615 can include an activity 617 of dividing an image 616 into small squares or tiles to generate images 618, which can include examples of the tiles, post division.

Returning to FIG. 6, in several embodiments, method 600 can include activity 620 of generating, using deep learning models, embeddings of each image 605 and image 610 to compare the textures between the two images. In various embodiments, activity 620 also can include generating the texture score for the rendered image by calculating the texture score based on the first embedding layers and the second embedding layers.

Turning ahead in the drawings, FIG. 6B illustrates a flowchart of activity 620 of generating, using deep learning models, embeddings, according to an embodiment. Activity 620 can be employed in many different embodiments and/or examples not specifically depicted or described herein. In some embodiments, the procedures, the processes, and/or the activities of activity 620 can be performed in the order presented or in parallel. In other embodiments, the procedures, the processes, and/or the activities of activity 620 can be performed in any suitable order. In still other embodiments, one or more of the procedures, the processes, and/or the activities of activity 620 can be combined or skipped.

In many embodiments, activity 620 can include an activity 622 of extracting, using a convolutional neural network (e.g., convnext) deep learning model, convnext embeddings 623 corresponding to a patch from an image 621. In several embodiments, extracting embeddings 623 can include extracting a patch from the rendered image and/or the reference image. In some embodiments, the embeddings of the patches can be compared using the slice loss function to create a texture score based on the comparison.

In various embodiments, activity 620 can include an activity of calculating the texture score based on first embedding layers and second embedding layers of the convolutional neural network.

Returning to FIG. 6, in several embodiments, method 600 can include an activity 625 of tuning, using a slice loss function, the deep learning model of activity 620. In some embodiments, activity 625 can include training parameters of the deep learning model based on the loss between the rendered image and the reference image to fine tune the texture score. In some embodiments, using the slice loss function, can determine the resemblance and/or disparity between the textures of two objects found in separate images. In various embodiments, the loss or distance can be computed from the embeddings yielded by the middle stages of the deep learning model when an image is supplied as input. In several embodiments, the embeddings can be subsequently projected in a random direction to execute activity 620. In various embodiments, an advantage of using the slice loss function can include (i) using a more tractable alternative by taking advantage of the sorting properties of one-dimensional data and (ii) measuring the distance between the cumulative distribution functions of the real and generated data when projected onto a random direction.

In various embodiments, method 600 can include activity 630 of determining whether or not a texture score comparing the rendered image and the reference image receives a passing score based a predetermined texture threshold. For example, if the texture score is less than the predetermined threshold, the texture score received a passing score. A passing score indicates whether the texture score in the rendered image matches the texture in the reference image within a range of degrees of similarity. If activity 630 is yes, then rendered image receives a score 640 of a passing score. If the activity 630 is no, then the rendered image receives a score 635 of flagging the rendered image as not passing the QC review. In several embodiments, method 600 can proceed after activity 630 back to activity 450 of transmitting the rendered images to a feedback loop and/or returning the rendered image to be regenerated by an artist into another 3D image.

Turning ahead in the drawings, FIG. 7 illustrates a flow chart for a method 700, according to another embodiment. In some embodiments, method 700 can be a method of automatically performing an artificial intelligence assisted quality control review of a 3D-asset. Method 700 is merely exemplary and is not limited to the embodiments presented herein. Method 700 can be employed in many different embodiments and/or examples not specifically depicted or described herein. In some embodiments, the procedures, the processes, and/or the activities of method 700 can be performed in the order presented. In other embodiments, the procedures, the processes, and/or the activities of method 700 can be performed in any suitable order. In still other embodiments, one or more of the procedures, the processes, and/or the activities of method 700 can be combined or skipped. In several embodiments, system 300 (FIG. 3) can be suitable to perform method 700 and/or one or more of the activities of method 700.

In these or other embodiments, one or more of the activities of method 700 can be implemented as one or more computing instructions configured to run at one or more processors and configured to be stored at one or more non-transitory computer-readable media. Such non-transitory computer-readable media can be part of a computer system such as quality scoring system 310 and/or web server 320. The processor(s) can be similar or identical to the processor(s) described above with respect to computer system 100 (FIG. 1).

Referring to FIG. 7, method 700 can include an alternate and/or optional activity 705 of transforming, using pose matching, a first pose of the rendered image to match a second pose of the reference image. Such an activity can be performed prior to inputting an image into the automated quality control pipeline. In several embodiments, activity 705 can be similar or identical to the activities of rendering, using a deep learning model of a machine learning framework, the reference image into a frontal pose in preparation for input as the reference image used in activity 424 and activity 440 as described above in activity 424 (FIG. 4) and/or similar or identical to the activities of executing, using the deep learning model, pose matching on the rendered image to transform the rendered image into a matching equivalent of the frontal pose of the reference image as described above in activity 430 (FIG. 4).

In several embodiments, method 700 also can include an alternate and/or optional activity 710 of removing, using a segmentation algorithm, pixels around a silhouette of the object from the rendered image and the reference image. In several embodiments, activity 710 can be similar or identical to the activities segmenting the reference image by removing pixels surrounding the object of the reference image and removing pixels in the background of the reference image so the object of the image is segmented to be viewed as a silo image described above in activities 422 and 432 (FIG. 4).

In some embodiments, method 700 additionally can include an activity 715 of obtaining a rendered image for a 3D-asset generated from a reference image of an object. In several embodiments, activity 715 can be similar or identical to the activities of determining whether or not to approve the reference image, as segmented, as an optimal reference image for use by activity 440, activity 445, and activity 450 as described above in activities 423 and 433 (FIG. 4).

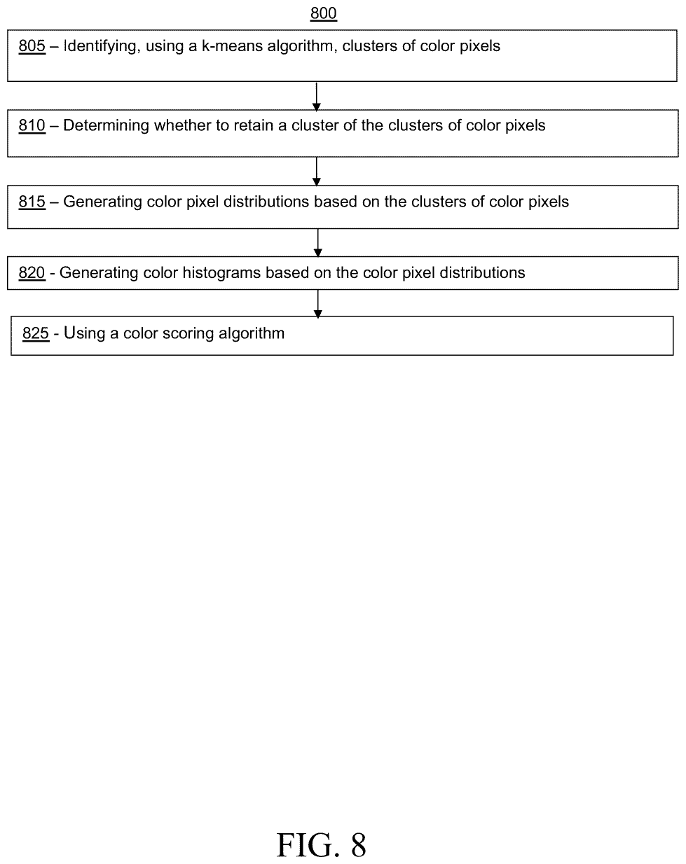

In various embodiments, method 700 can include an activity 720 of generating, using a machine learning model, a color score for the rendered image based on a first color histogram for the rendered image and a second color histogram for the reference image. In several embodiments, activity 720 can be similar or identical to the activities of determining total overall color score for the rendered image of based on activity 565, determining a dominant color distance of the colors for the rendered image based on an activity 567, and/or determining a list of missing colors between the rendered image and the reference image based on activity 569. In some embodiments, activity 720 can be implemented as shown in method 800 (FIG. 8, described below).

In a number of embodiments, method 700 can include an activity 725 of generating, using a deep learning model and a slice loss function, a texture score for the rendered image. In several embodiments, activity 725 can be similar or identical to the activities of determining whether or not a texture score comparing the rendered image and the reference image receives a passing score based a predetermined texture threshold described above in activities 630 (FIG. 6). In some embodiments, activity 720 can be implemented as shown in method 900 (FIG. 9, described below). In various embodiments, the deep learning model, can build upon previously existing deep learning models by modifying the training data set and the data preparation techniques. In several embodiments, the deep learning model can generate embeddings output from the intermediate layers of the model when the images are provided to them as an input. In some embodiments, the output or embeddings also can be used for calculating the slice loss function.

In various embodiments, method 700 include an activity 730 of determining a quality score for the rendered image based on a predetermined quality threshold and a combination of the color score and the texture score. In several embodiments, activity 730 can be similar or identical to the activities validating the rendered image (3D image) can be based on combining a color score and a texture score tied together to provide a pass or fail result based on the scores described above in activities 450 (FIG. 4).

In several embodiments, method 700 can include an activity 735 of inputting, using a feedback loop, the quality score for the rendered image into a training dataset for the machine learning model. In several embodiments, activity 735 can be similar or identical to the activities of transmitting the rendered images unvalidated to a manual quality review described above in activity 430 (FIG. 4).

In some embodiments, method 700 can include an activity 740 of updating, using the feedback loop, parameters of the training dataset based on the quality score. In several embodiments, activity 740 can be similar or identical to the activities of updating training datasets periodically for use by AI assisted machine learning models as used throughout the automated QC pipeline discussed in FIG. 4 described above in activity 430 (FIG. 4).

Turning ahead in the drawings, FIG. 8 illustrates a flow chart for a method 800, according to another embodiment. In some embodiments, method 800 can be a method of automatically generating, using a color quality scoring algorithm in a machine learning model, a color score of the 3D-asset based on a comparison of the reference image of the catalog object. In many embodiments, method 800 also can include generating machine learning assisted color histograms using the color quality scoring algorithm. Method 800 is merely exemplary and is not limited to the embodiments presented herein. Method 800 can be employed in many different embodiments and/or examples not specifically depicted or described herein. In some embodiments, the procedures, the processes, and/or the activities of method 800 can be performed in the order presented. In other embodiments, the procedures, the processes, and/or the activities of method 800 can be performed in any suitable order. In still other embodiments, one or more of the procedures, the processes, and/or the activities of method 800 can be combined or skipped. In several embodiments, system 300 (FIG. 3) can be suitable to perform method 800 and/or one or more of the activities of method 800.

In these or other embodiments, one or more of the activities of method 800 can be implemented as one or more computing instructions configured to run at one or more processors and configured to be stored at one or more non-transitory computer-readable media. Such non-transitory computer-readable media can be part of a computer system such as quality scoring system 310 and/or web server 320. The processor(s) can be similar or identical to the processor(s) described above with respect to computer system 100 (FIG. 1).

Referring to FIG. 8, method 800 can include an activity 805 of identifying, using a k-means algorithm, clusters of color pixels of the rendered image and the reference image. In several embodiments, activity 805 can be similar or identical to the activities of generating, using k-means clustering algorithm, multiple color clusters of colors corresponding to the rendering image and/or the reference image as described above in activity 515 (FIG. 5).

In some embodiments, method 800 also can include an activity 810 of determining whether to retain a cluster of the clusters of color pixels of the rendered image and the reference image based on a predetermined threshold. In several embodiments, activity 810 can be similar or identical to sorting the colors clusters by retaining the color in activity 521 or activity 522 of merging the two colors with an aggregated (e.g., bigger) color and/or of retaining the color cluster for input into activity 541 as described above in activities 521 and 539 (FIG. 5).

In several activities, method 800 additionally can include an activity 815 of generating color pixel distributions based on the clusters of color pixels for the rendered image and the reference image. In several embodiments, activity 815 can be similar or identical to the activities of using inter cluster lab color distances (lab color distances), to determine a plotted color distance (e.g., color differences) or a separation distance between two colors and/or described above in activities 520, 523 (FIG. 5).

In various embodiments, method 800 further can include an activity 820 of generating color histograms based on the color pixel distributions for the rendered image and the reference image. In several embodiments, activity 820 can be similar or identical to the activities of generating color histograms based on the color clusters generated by the k-means clustering algorithm in activity 515, and/or determining a color score based on how the proportions of the colors in the rendered image and the reference image are matched in the images as the color histogram includes the color information of the object in the images as described above in activity 524 (FIG. 5).

In a number of embodiments, method 800 also can include an activity 825 of using a color scoring algorithm. In several embodiments, activity 825 can be similar or identical to the activities of determining, using a scoring algorithm, color scores for the rendered image and/or the colors scores can include overall score 566, dominant color distance 568, and/or list of missing colors 570.

In several embodiments, the color scoring algorithm further can include color mapping the rendered image and the reference image to clusters of color pixels. In some embodiments, the color scoring algorithm also can include dividing the clusters of color pixels into quartiles. In various embodiments, the color scoring algorithm additionally can include assigning weights to each quartile. In many embodiments, the color scoring algorithm also can include assigning quality scores to the rendered image and the reference image based on the weights of each quartile.

In a number of embodiments, the color scoring algorithm can output at least one of an overall score 566, a dominant color distance 568, and/or a list of missing colors 570. In various embodiments, each output of the color scoring algorithm is configured to assess the reference image and rendered image from different perspectives or points of view. In some embodiments, overall score 566 can be based on the distance between the color histograms, such as histogram 546 and histogram 551. In several embodiments, overall score 566 can include evaluating a degree of correctness of the color at an overall image level based on a predetermined threshold. In various embodiments, overall score 566 can be subject to constraints as clustering color can cause similar colors to be grouped together in one color, for example, the colors of light blue and light gray can be grouped together even the colors are different colors. In several embodiments, list of missing colors 570 can determine whether a color is present in the reference image and/or missing in the rendered image, where missing colors can be flagged for color disparity. In various embodiments, even if the set of colors are identically present in both the rendered image and the reference image, dominant color distance 568 can validate that a dominant color is present in the images to (i) show that the composition of the color (e.g., distribution) of the primary color can be near similar and (ii) avoid incorrect pseudo positive decisions of color.

Turning ahead in the drawings, FIG. 9 illustrates a flow chart for a method 900, according to another embodiment. In some embodiments, method 900 can be a method of automatically determining, using a texture quality control evaluation algorithm of a machine learning model to generate a texture quality score. In many embodiments, automatically determining the texture quality score an include using a slice loss function to determine the texture quality score between the 3D-asset and the reference image. Method 900 is merely exemplary and is not limited to the embodiments presented herein. Method 900 can be employed in many different embodiments and/or examples not specifically depicted or described herein. In some embodiments, the procedures, the processes, and/or the activities of method 900 can be performed in the order presented. In other embodiments, the procedures, the processes, and/or the activities of method 900 can be performed in any suitable order. In still other embodiments, one or more of the procedures, the processes, and/or the activities of method 900 can be combined or skipped. In several embodiments, system 300 (FIG. 3) can be suitable to perform method 900 and/or one or more of the activities of method 900.

In these or other embodiments, one or more of the activities of method 900 can be implemented as one or more computing instructions configured to run at one or more processors and configured to be stored at one or more non-transitory computer-readable media. Such non-transitory computer-readable media can be part of a computer system such as quality scoring system 310 and/or web server 320. The processor(s) can be similar or identical to the processor(s) described above with respect to computer system 100 (FIG. 1).

Referring to FIG. 9, method 900 can include an activity 905 of extracting, using the deep learning model, a first texture patch from the rendered image by dividing the rendered image into multiple first tiles. In several embodiments, activity 905 can be similar or identical to the activities of extracting, using a convolutional neural network deep learning model, convolutional neural network (e.g., convnext) embeddings 623 corresponding to a patch from an image 621, extracting embeddings 623 can include extracting a patch from the rendered image and/or the reference image, as described above in activities 622 (FIG. 6).

In some embodiments, method 900 also can include an activity 910 of transforming, using a convolutional neural network, first visual data from the first texture patch into first embedding layers. In several embodiments, activity 910 can be similar or identical to the activities of determining whether or not a texture score comparing the rendered image and the reference image receives a passing score based a predetermined texture threshold as described above in activities 630 (FIG. 6).

In various embodiments, method 900 further can include an activity 915 of extracting, using the deep learning model, a second texture patch from the reference image by dividing the reference image into multiple second tiles. In several embodiments, activity 915 can be similar or identical to the activities of extracting, using a convolutional neural network deep learning model, convnext embeddings 623 corresponding to a patch from an image 621, extracting embeddings 623 can include extracting a patch from the rendered image and/or the reference image, as described above in activities 622 (FIG. 6).

In several embodiments, method 900 additionally can include an activity 920 of transforming, using the convolutional neural network, second visual data from the second texture patch into second embedding layers.

In a number of embodiments, method 900 also can include an activity 925 of calculating the texture score based on the first embedding layers and the second embedding layers.

In various embodiments, method 900 further an include an activity 930 of calculating, suing the slice loss function, a loss.

Returning to FIG. 3, communication system 311 can at least partially perform activity 410 (FIG. 4) can include executing a command to run a script and/or computing instructions to generate a digital reference image and a digital rendered image of the object (e.g., item), and/or activity 715 (FIG. 7) of obtaining a rendered image for a 3D-asset generated from a reference image of an object.

In many embodiments, machine learning model system 312 can at least partially perform activity 720 (FIG. 7) of generating, using a machine learning model, a color score for the rendered image based on a first color histogram for the rendered image and a second color histogram for the reference image, and/or activity 622 (FIG. 6) of extracting, using a convnext deep learning model, convnext embeddings 623 (FIG. 6) corresponding to a patch from an image 621 (FIG. 6).

In some embodiments, loss function system 313 can at least partially perform activity 625 (FIG. 6) of tuning, using a slice loss function, the deep learning model of activity 620 (FIG. 6), activity 630 (FIG. 6) of determining whether or not a texture score comparing the rendered image and the reference image receives a passing score based a predetermined texture threshold, and/or activity 725 (FIG. 7) of generating, using a deep learning model and a slice loss function, a texture score for the rendered image.

In several embodiments, pose matching system 314 can at least partially perform activity 420 (FIG. 4) of classifying, using a silo image classifier, the 3D image into either a silo image or a non-silo image, rendering, using a deep learning model of a machine learning framework, the reference image into a frontal pose in preparation for input as the reference image used in activity 424 (FIG. 4) and activity 440 (FIG. 4), activity 430 (FIG. 4) also can include executing, using the deep learning model, pose matching on the rendered image to transform the rendered image into a matching equivalent of the frontal pose of the reference image, activity 431 (FIG. 4) of determining whether or not to approve the rendered image as an optimal rendered image for use by an activity 432 (FIG. 4), activity 422 (FIG. 4) can include transmitting the reference image, as segmented, to an activity 423 (FIG. 4) of determining whether or not to approve the reference image, as segmented, as an optimal reference image for use by activity 440 (FIG. 4), activity 445 (FIG. 4), and activity 450 (FIG. 4), and/or activity 705 (FIG. 7) of transforming, using pose matching, a first pose of the rendered image to match a second pose of the reference image.

In a number of embodiments, segmentation system 315 can at least partially perform activity 432 (FIG. 4) also can include segmenting the rendered image in a frontal pose by removing pixels surrounding the object of the image and removing pixels in the background of the rendered image so the object of the rendered image is segmented to be viewed as a silo image, and/or activity 710 (FIG. 7) of removing, using a segmentation algorithm, pixels around a silhouette of the object from the rendered image and the reference image.

In various embodiments, clustering system 316 can at least partially perform, activity 567 (FIG. 5) of determining a color distance (e.g., lab color distance) between the most dominant colors in both the color clusters of the rendered image and the reference image, activity 569 (FIG. 5) of determining a list of missing colors between the rendered image and the reference image, activity 805 (FIG. 8) of generating the color score by identifying, using a k-means algorithm, clusters of color pixels of the rendered image and the reference image, activity 810 (FIG. 8) of generating the color score by determining whether to retain a cluster of the clusters of color pixels of the rendered image and the reference image based on a predetermined threshold, and/or activity 815 (FIG. 8) of generating the color score by generating color pixel distributions based on the clusters of color pixels for the rendered image and the reference image.

In some embodiments, histogram system 317 can at least partially perform activity 524 (FIG. 5) of generating color histograms based on the color clusters generated by the k-means clustering algorithm in activity 515 (FIG. 5), and/or activity 820 (FIG. 8) of generating the color score by generating color histograms based on the color pixel distributions for the rendered image and the reference image.

In several embodiments, color scoring system 318 can at least partially perform activity 515 (FIG. 5) of generating, using k-means clustering algorithm, multiple color clusters of colors corresponding to the rendering image and/or the reference image, activity 517 (FIG. 5) of using k-means clustering algorithm to obtain clusters of distinct colors for use in machine learning assisted color histograms for an image, such as the rendered image and/or the reference image, activity 520 (FIG. 5) of determining whether or not the color clusters between two images are similar enough to one another by exceeding a predetermined color distance threshold, activity 523 (FIG. 5) of refining RGB clusters with distinct colors based on activity 521 (FIG. 5) and activity 522 (FIG. 5), activity 535 (FIG. 5) of resolving color mapping between the color clusters of two images based on histogram 526 (FIG. 5) and histogram 531, activity 538 of determining whether or not to retain a color cluster of an image based on a score exceeding a predetermined threshold, activity 539 (FIG. 5) of retaining the color cluster for input into activity 541, activity 540 of mapping the color cluster of the rendered image to the color cluster of the reference image, activity 541 (FIG. 5) of color mapping the rendered image based on the color clusters output by activity 539 (FIG. 5) and activity 540 (FIG. 5), activity 563 (FIG. 5) of dividing the color clusters into quartiles based on a percentage of color clusters with hex codes, an activity 564 (FIG. 5) of assigning a weight to each quartile, activity 565 (FIG. 5) can include determining a total score of the rendered image based on the following formula: for each color in reference score+=abs (a percentage of color in reference image cluster−a percentage of color in the rendered image cluster (e.g., target cluster)*a quartile weigh of a cluster, activity 567 (FIG. 5) of determining a color distance (e.g., lab color distance) between the most dominant colors in both the color clusters of the rendered image and the reference image, activity 569 (FIG. 5) of determining a list of missing colors between the rendered image and the reference image, activity 805 (FIG. 5) of generating the color score by identifying, using a k-means algorithm, clusters of color pixels of the rendered image and the reference image, activity 810 (FIG. 8) of generating the color score by determining whether to retain a cluster of the clusters of color pixels of the rendered image and the reference image based on a predetermined threshold, activity 815 (FIG. 8) of generating the color score by generating color pixel distributions based on the clusters of color pixels for the rendered image and the reference image, activity 820 (FIG. 8) of generating the color score by generating color histograms based on the color pixel distributions for the rendered image and the reference image, and/or activity 825 (FIG. 8) of generating the color score can include using a color scoring algorithm.

In many embodiments, texture scoring system 319 can at least partially perform activity 617 (FIG. 6) of dividing an image 616 (FIG. 6) into small squares or tiles, generating, using deep learning models, embeddings of each image 605 (FIG. 6) and image 610 (FIG. 6) to compare the textures between the two images, and/or activity 622 (FIG. 6) of extracting, using a convnext deep learning model, convnext embeddings 623 (FIG. 6) corresponding to a patch from an image 621 (FIG. 6).

In several embodiments, web server 320 can include a webpage system 321. Webpage system 321 can at least partially perform sending instructions to user computers (e.g., 350-351 (FIG. 3)) based on information received from communication system 311.

In many embodiments, training system 322 can at least partially perform activity 735 (FIG. 7) of inputting, using a feedback loop, the quality score for the rendered image into a training dataset for the machine learning model, and/or activity 740 (FIG. 7) of updating, using the feedback loop, parameters of the training dataset based on the quality score.

In many embodiments, scoring system 323 can at least partially perform activity 450 (FIG. 4) of validating the rendered image (3D image) can be based on combining a color score and a texture score tied together to provide a pass or fail result based on the scores, activity 560 (FIG. 5), of determining, using a scoring algorithm, color scores for the rendered image based on a degree of similarity matching the reference image, activity 730 (FIG. 7) of determining a quality score for the rendered image based on a predetermined quality threshold and a combination of the color score and the texture score, and/or activity 735 (FIG. 7) of inputting, using a feedback loop, the quality score for the rendered image into a training dataset for the machine learning model.

In many embodiments, the techniques described herein can be used continuously at a scale that cannot be handled using manual techniques. For example, the number of daily and/or monthly visits to the content source can exceed approximately ten million and/or other suitable numbers, the number of registered users to the content source can exceed approximately one million and/or other suitable numbers, and/or the number of products and/or items sold on the website can exceed approximately ten million (10,000,000) approximately each day.

In a number of embodiments, the techniques described herein can solve a technical problem that arises only within the realm of computer networks, as automating a QC review of a 3D artist rendered image, does not exist outside the realm of computer networks. Moreover, the techniques described herein can solve a technical problem that cannot be solved outside the context of computer networks. Specifically, the techniques described herein cannot be used outside the context of computer networks, in view of a lack of data, and because a content catalog, such as an online catalog, that can power and/or feed an online website that is part of the techniques described herein would not exist.

In several embodiments, an automated quality control check can reduce time expended in a manual quality review and eliminate subject bias can be advantageous. In many embodiments, a validated 3D-asset can be stored in a database ready to be utilized within a digital environment such as an Augmented Reality (AR) scene, a virtual try-on (VTO) space, and/or another suitable digital environment.

Various embodiments can include a system including a processor and a non-transitory computer-readable media storing computing instructions that, when executed on the processor, cause the processor to perform certain operations. The operations can include obtaining a rendered image for a 3D-asset generated from a reference image of an object. The operations also can include generating, using a machine learning model, a color score for the rendered image based on a first color histogram for the rendered image and a second color histogram for the reference image. The operations additionally can include generating, using a deep learning model and a slice loss function, a texture score for the rendered image. The acts operations can include determining a quality score for the rendered image based on a predetermined quality threshold and a combination of the color score and the texture score.

A number of embodiments can include a computer-implemented method. The method can include obtaining a rendered image for a 3D-asset generated from a reference image of an object. The method also can include generating, using a machine learning model, a color score for the rendered image based on a first color histogram for the rendered image and a second color histogram for the reference image. The method additionally can include generating, using a deep learning model and a slice loss function, a texture score for the rendered image. The method also can include determining a quality score for the rendered image based on a predetermined quality threshold and a combination of the color score and the texture score.

Additional embodiments can include a non-transitory computer-readable media storing computing instructions that, when executed on a processor, cause the processor to perform certain operations. The operations can include obtaining a rendered image for a 3D-asset generated from a reference image of an object. The operations also can include generating, using a machine learning model, a color score for the rendered image based on a first color histogram for the rendered image and a second color histogram for the reference image. The operations additionally can include generating, using a deep learning model and a slice loss function, a texture score for the rendered image. The operations further can include determining a quality score for the rendered image based on a predetermined quality threshold and a combination of the color score and the texture score.

Although automatically performing an artificial intelligence assisted quality control review of a 3D-asset has been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-9 may be modified, and that the foregoing discussion of certain of these embodiments does not necessarily represent a complete description of all possible embodiments. For example, one or more of the procedures, processes, or activities of FIGS. 7-9 may include different procedures, processes, and/or activities and be performed by many different modules, in many different orders, and/or one or more of the procedures, processes, or activities of FIGS. 7-9 may include one or more of the procedures, processes, or activities of another different one of FIGS. 7-9. Additional details, quality scoring system 310 can include a communication system 311, a machine learning model system 312, a loss function system 313, a pose matching system 314, a segmentation system 315, a clustering system 316, a histogram system 317, a color scoring system 318, a texture scoring system 319, a training system 322, and/or a scoring system 323 (FIGS. 3, 7-9) can be interchanged or otherwise modified.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising a processor and a non-transitory computer-readable medium storing computing instructions that, when executed on the processor, cause the processor to perform operations comprising:
obtaining a rendered image for a 3D-asset generated from a reference image of an object;
generating, using a machine learning model, a color score for the rendered image based on a first color histogram for the rendered image and a second color histogram for the reference image;
generating, using a deep learning model and a slice loss function, a texture score for the rendered image; and
determining a quality score for the rendered image based on a predetermined quality threshold and a combination of the color score and the texture score.

2. The system of claim 1, wherein the operations further comprise:
transforming, using pose matching, a first pose of the rendered image to match a second pose of the reference image; and
removing, using a segmentation algorithm, pixels around a silhouette of the object from the rendered image and the reference image.

3. The system of claim 1, wherein generating the color score comprises:
identifying, using a k-means algorithm, clusters of color pixels of the rendered image and the reference image; and
determining whether to retain a cluster of the clusters of color pixels of the rendered image and the reference image based on a predetermined threshold.

4. The system of claim 3, wherein generating the color score further comprises:
generating color pixel distributions based on the clusters of color pixels for the rendered image and the reference image; and
generating color histograms based on the color pixel distributions for the rendered image and the reference image.

5. The system of claim 1, wherein generating the color score comprises using a color scoring algorithm.

6. The system of claim 5, wherein the color scoring algorithm comprises:
color mapping the rendered image and the reference image to clusters of color pixels;
dividing the clusters of color pixels into quartiles;
assigning weights to each quartile; and
assigning quality scores to the rendered image and the reference image based on the weights of each quartile.

7. The system of claim 6, wherein the color scoring algorithm outputs at least one of:
an overall quality score;
a dominant color distance; or
a list of missing colors.

8. The system of claim 1, wherein generating the texture score for the rendered image comprises:
extracting, using the deep learning model, a first texture patch from the rendered image by dividing the rendered image into multiple first tiles;
transforming, using a convolutional neural network, first visual data from the first texture patch into first embedding layers;
extracting, using the deep learning model, a second texture patch from the reference image by dividing the reference image into multiple second tiles;
transforming, using the convolutional neural network, second visual data from the second texture patch into second embedding layers; and
calculating the texture score based on the first embedding layers and the second embedding layers.

9. The system of claim 8, wherein generating the texture score for the rendered image further comprises:
calculating, using the slice loss function, a loss between the rendered image and the reference image.

10. The system of claim 1, wherein the operations further comprise:
inputting, using a feedback loop, the quality score for the rendered image into a training dataset for the machine learning model; and
updating, using the feedback loop, parameters of the training dataset based on the quality score.

11. A computer-implemented method comprising:
obtaining a rendered image for a 3D-asset generated from a reference image of an object;
generating, using a machine learning model, a color score for the rendered image based on a first color histogram for the rendered image and a second color histogram for the reference image;
generating, using a deep learning model and a slice loss function, a texture score for the rendered image; and
determining a quality score for the rendered image based on a predetermined quality threshold and a combination of the color score and the texture score.

12. The computer-implemented method of claim 11 further comprising:
transforming, using pose matching, a first pose of the rendered image to match a second pose of the reference image; and
removing, using a segmentation algorithm, pixels around a silhouette of the object from the rendered image and the reference image.

13. The computer-implemented method of claim 11, wherein generating the color score comprises:
identifying, using a k-means algorithm, clusters of color pixels of the rendered image and the reference image; and
determining whether to retain a cluster of the clusters of color pixels of the rendered image and the reference image based on a predetermined threshold.

14. The computer-implemented method of claim 13, wherein generating the color score further comprises:
generating color pixel distributions based on the clusters of color pixels for the rendered image and the reference image; and
generating color histograms based on the color pixel distributions for the rendered image and the reference image.

15. The computer-implemented method of claim 11, wherein generating the color score comprises using a color scoring algorithm.

16. The computer-implemented method of claim 15, wherein the color scoring algorithm comprises:
color mapping the rendered image and the reference image to clusters of color pixels;
dividing the clusters of color pixels into quartiles;
assigning weights to each quartile; and
assigning quality scores to the rendered image and the reference image based on the weights of each quartile.

17. The computer-implemented method of claim 16, wherein the color scoring algorithm outputs at least one of:
an overall quality score;
a dominant color distance; or
a list of missing colors.

18. The computer-implemented method of claim 11, wherein generating the texture score for the rendered image comprises:
extracting, using the deep learning model, a first texture patch from the rendered image by dividing the rendered image into multiple first tiles;
transforming, using a convolutional neural network, first visual data from the first texture patch into first embedding layers;
extracting, using the deep learning model, a second texture patch from the reference image by dividing the reference image into multiple second tiles;
transforming, using the convolutional neural network, second visual data from the second texture patch into second embedding layers; and
calculating the texture score based on the first embedding layers and the second embedding layers.

19. A non-transitory computer-readable medium storing computing instructions that, when executed on a processor, cause the processor to perform operations comprising:
obtaining a rendered image for a 3D-asset generated from a reference image of an object;
generating, using a machine learning model, a color score for the rendered image based on a first color histogram for the rendered image and a second color histogram for the reference image;
generating, using a deep learning model and a slice loss function, a texture score for the rendered image; and
determining a quality score for the rendered image based on a predetermined quality threshold and a combination of the color score and the texture score.

20. The non-transitory computer-readable medium of claim 19, wherein the operations further comprise:
transforming, using pose matching, a first pose of the rendered image to match a second pose of the reference image; and
removing, using a segmentation algorithm, pixels around a silhouette of the object from the rendered image and the reference image.
